(19) United States
(12) Patent Application Publication
(10) Pub. No.: US 2025/0310441 A1
(43) Pub. Date: Oct. 2, 2025

(54) INFORMATION PROCESSING SYSTEM, IMAGE FORMING APPARATUS, AND NON-TRANSITORY COMPUTER READABLE MEDIUM STORING PROGRAM

(71) Applicant: FUJIFILM Business Innovation Corp., Tokyo (JP)

(72) Inventor: Tomoya OKI, Kanagawa (JP)

(73) Assignee: FUJIFILM Business Innovation Corp., Tokyo (JP)

(21) Appl. No.: 18/779,110

(22) Filed: Jul. 22, 2024

(30) Foreign Application Priority Data
Mar. 26, 2024 (JP) 2024-050122

(51) Int. Cl. H04N 1/00

(52) U.S. Cl. CPC H04N 1/00029; H04N 1/00071

(57) ABSTRACT

An information processing system includes: a processor configured to: acquire post-action image information that is information on a post-action image, which is an image formed by an image forming apparatus after an action is performed on the image forming apparatus by an action operator; acquire pre-action image information that is information on a pre-action image, which is an image formed by the image forming apparatus before the action is performed by the action operator; and generate state information that is information on a state of the image forming apparatus, based on the post-action image information and the pre-action image information.

### CROSS-REFERENCE TO RELATED APPLICATIONS

This application is based on and claims priority under 35 USC 119 from Japanese Patent Application No. 2024-050122 filed Mar. 26, 2024.

### BACKGROUND

### (i) Technical Field

The present invention relates to an information processing system, an image forming apparatus, and a non-transitory computer readable medium storing a program.

### (ii) Related Art

JP2015-167302A discloses an image forming apparatus including a selection section that selects one or a plurality of charts from a plurality of diagnosis charts by using an image feature associated with a selected page, and an output section that outputs the selected chart.

### SUMMARY

By analyzing an image formed by the image forming apparatus, information on a state of the image forming apparatus can be generated.

Here, in a case where the information on the state of the image forming apparatus is generated based on only one image formed by the image forming apparatus, there is a risk that the state cannot be narrowed down and accuracy of the information on the state of the image forming apparatus may be lowered.

Aspects of non-limiting embodiments of the present disclosure relate to an information processing system, an image forming apparatus, and a non-transitory computer readable medium storing a program that improve accuracy of information on a state of an image forming apparatus, as compared with a case where the information on the state of the image forming apparatus is generated based on only one image formed by the image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: acquire post-action image information that is information on a post-action image, which is an image formed by an image forming apparatus after an action is performed on the image forming apparatus by an action operator; acquire pre-action image information that is information on a pre-action image, which is an image formed by the image forming apparatus before the action is performed by the action operator; and generate state information that is information on a state of the image forming apparatus, based on the post-action image information and the pre-action image information.

### BRIEF DESCRIPTION OF THE DRAWINGS

Exemplary embodiment(s) of the present invention will be described in detail based on the following figures, wherein:

FIG. 1 is a diagram illustrating an example of a diagnosis system;

FIG. 2 is a diagram illustrating an example of a hardware configuration of a server apparatus and an information processing unit provided in an image forming apparatus;

FIG. 3 is a diagram describing the image forming apparatus;

FIG. 4 is a diagram describing details of a diagnosis process by the server apparatus;

FIG. 5 is a diagram illustrating a screen that is referred to by an action operator;

FIG. 6 is a diagram illustrating a post-action image formed after “replacement of photosensitive drum of Magenta” is performed; and

FIG. 7 is an enlarged view of a developing device.

### DETAILED DESCRIPTION

Hereinafter, an exemplary embodiment of the present disclosure will be described with reference to the accompanying drawings.

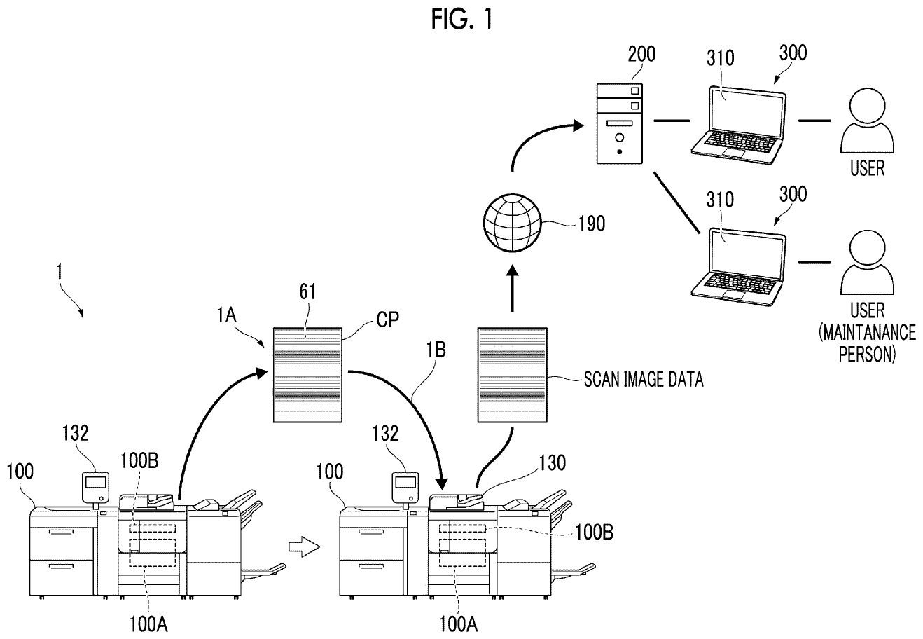

FIG. 1 is a diagram illustrating an example of a diagnosis system 1.

The diagnosis system 1 according to the present exemplary embodiment is provided with a plurality of image forming apparatuses 100 and a server apparatus 200 that is connected to each of the plurality of image forming apparatuses 100 via a communication line 190.

In FIG. 1, two image forming apparatuses 100 among the plurality of image forming apparatuses 100 are displayed.

In the present exemplary embodiment, in the server apparatus 200 as an example of an information processing system, diagnosis of each image forming apparatus 100 is performed. In the present exemplary embodiment, in the server apparatus 200, state information, which is information on a state of each of the image forming apparatuses 100, is generated.

The diagnosis system 1 further includes a user terminal 300. The user terminal 300 is connected to the server apparatus 200. The user terminal 300 receives an operation from a user.

In the present exemplary embodiment, the user of the image forming apparatus 100 or a maintenance person of the image forming apparatus 100 refers to information displayed on the user terminal 300.

The user terminal 300 is provided with a display device 310.

The user terminal 300 is realized by a computer. Examples of a form of the user terminal 300 include a personal computer (PC), a smartphone, and a tablet terminal.

The image forming apparatus 100 is provided with a forming function unit 100A as an example of an image forming section that forms an image on paper which is an example of a recording medium.

The image forming apparatus 100 is further provided with an information processing unit 100B. The information processing unit 100B executes various processes executed in the image forming apparatus 100.

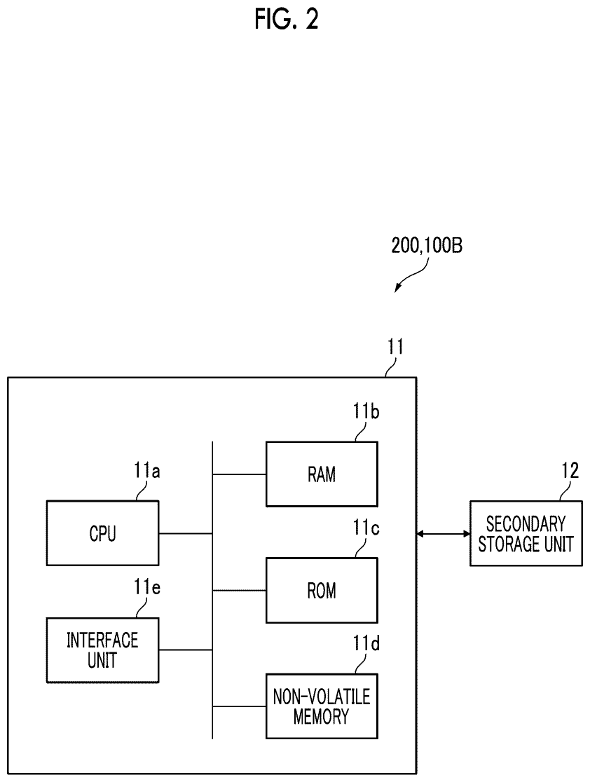

FIG. 2 is a diagram illustrating an example of a hardware configuration of the server apparatus 200 and the information processing unit 100B provided in the image forming apparatus 100. The server apparatus 200 and the information processing unit 100B provided in the image forming apparatus 100 are realized by a computer.

Each of the server apparatus 200 and the information processing unit 100B includes an arithmetic processing unit 11 that executes a digital arithmetic process according to a program, and a secondary storage unit 12 that stores information.

The secondary storage unit 12 is realized, for example, by a known information storage device such as a hard disk drive (HDD), a semiconductor memory, or a magnetic tape.

The arithmetic processing unit 11 is provided with a CPU 11a as an example of a processor.

In addition, the arithmetic processing unit 11 is provided with a RAM 11b used as a working memory or the like of the CPU 11a and a ROM 11c in which programs or the like executed by the CPU 11a are stored.

In addition, the arithmetic processing unit 11 is provided with a non-volatile memory 11d that is configured to be rewritable and can hold data even in a case where power supply is interrupted and an interface unit 11e that controls each unit, such as a communication unit, connected to the arithmetic processing unit 11.

The non-volatile memory 11d is configured with, for example, an SRAM or a flash memory that is backed up by a battery. The secondary storage unit 12 stores the programs executed by the arithmetic processing unit 11 in addition to files and the like.

In the present exemplary embodiment, the CPU 11a reads the program stored in the ROM 11c or the secondary storage unit 12 to execute each process.

The program executed by the CPU 11a can be provided to the server apparatus 200 and the information processing unit 100B in a state in which the program is stored in a computer-readable recording medium such as a magnetic recording medium (for example, a magnetic tape or a magnetic disk), an optical recording medium (for example, an optical disk), a magneto-optical recording medium, or a semiconductor memory. Further, the program executed by the CPU 11a may be provided to the server apparatus 200 and the information processing unit 100B by a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process executed by the image forming apparatus 100 among the processes described below is executed by the CPU 11a as an example of the processor provided in the image forming apparatus 100. The process executed by the server apparatus 200 among the processes described below is executed by the CPU 11a as an example of the processor provided in the server apparatus 200.

Further, the process related to diagnosis on the image forming apparatus 100 among the processes described below is executed by the server apparatus 200 as an example of an information processing system.

The information processing system that performs the process related to the diagnosis on the image forming apparatus 100 may be realized by one apparatus such as one server apparatus 200 or may be realized by a plurality of apparatuses. In addition, the information processing system that performs the process related to the diagnosis on the image forming apparatus 100 may be provided in the image forming apparatus 100. In this case, the image forming apparatus 100 performs the process related to the diagnosis on the image forming apparatus 100.

The “information processing system” in the present exemplary embodiment is configured with a single apparatus as an example, and may be configured with a plurality of apparatuses.

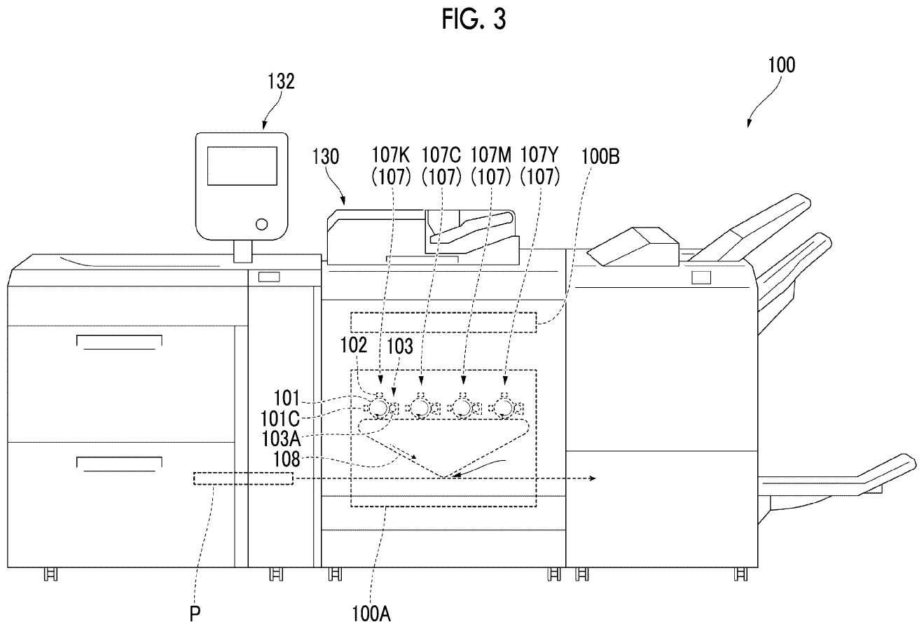

FIG. 3 is a diagram describing the image forming apparatus 100.

In the present exemplary embodiment, as described above, the forming function unit 100A that functions as an image forming section which forms an image on paper P which is an example of a recording medium is provided in the image forming apparatus 100. The image formation on the paper P by the forming function unit 100A is performed by using an electrophotographic method.

The forming function unit 100A is provided with an intermediate transfer belt 108 as a member that moves around and a plurality of image forming units 107 that form images of colors different from each other.

In the present exemplary embodiment, the image formed by each of the plurality of image forming units 107 is temporarily transferred to the intermediate transfer belt 108, and then transferred to the paper P.

The plurality of image forming units 107 form the images of colors different from each other on the intermediate transfer belt 108. The intermediate transfer belt 108 may not be provided, and a configuration in which the image is directly transferred to the paper P from each of the plurality of image forming units 107 may be adopted.

In addition, the plurality of image forming units 107 may not be provided, and a configuration in which only one image forming unit 107 is provided may be adopted. In a case of the configuration in which only one image forming unit 107 is provided, the intermediate transfer belt 108 is omitted.

In the present exemplary embodiment, as the image forming unit 107, an image forming unit 107Y that forms an image of Yellow, an image forming unit 107M that forms an image of Magenta, an image forming unit 107C that forms an image of Cyan, and an image forming unit 107K that forms an image of Black are provided.

The image formed by each of the image forming units 107 is transferred to the intermediate transfer belt 108 as an example of a transfer member. Thereafter, at a transfer unit T, this image is transferred to the paper P transported to the transfer unit T. Therefore, an image is formed on the paper P.

A photosensitive drum 101 as an example of an image holding body is provided in each of the image forming units 107. The photosensitive drum 101 is rotated in a clockwise direction. Further, in each of the image forming units 107, a charging device 101C that performs charging on the photosensitive drum 101 and an exposure device 102 that performs exposing on the photosensitive drum 101 are provided.

Further, a developing device 103 that performs development on an electrostatic latent image formed on the photosensitive drum 101 by the exposure by the exposure device 102 is provided in each of the image forming units 107.

The developing device 103 is provided with a developing roll 103A disposed at a position facing the photosensitive drum 101. The developing roll 103A is rotated. In the present exemplary embodiment, development is performed by a developer adhering to an outer peripheral surface of the developing roll 103A moving to a surface of the photosensitive drum 101.

In a case where the development is performed, an image by, for example, a toner is formed on the photosensitive drum 101. Thereafter, this image is transferred to an outer circumferential surface of the intermediate transfer belt 108. Thereafter, in the present exemplary embodiment, this image on the intermediate transfer belt 108 is transferred to the paper P, and the image is formed on the paper P.

The formation of the image on the paper P by the forming function unit 100A is not limited to the electrophotographic method, and other methods such as an ink jet method may be used.

The image forming apparatus 100 is further provided with an image scanning device 130. In addition, the image forming apparatus 100 has an information transmission function to transmit information to the server apparatus 200 (see FIG. 1).

This image scanning device 130 as an example of an image scanning section is a so-called scanner that scans an image formed on paper (not illustrated) as an example of a recording medium.

The image scanning device 130 includes a light source that emits light with which paper is to be irradiated and a light receiving unit such as a CCD that receives reflected light from the paper. In the present exemplary embodiment, scan image data described below is generated based on the reflected light received by the light receiving unit.

The image scanning device 130 according to the present exemplary embodiment has a function of transporting a sheet.

A scanning position of an image is set in advance in the image scanning device 130, and the image scanning device 130 scans an image at a portion of paper that is sequentially transported, which is located at the scanning position.

In the example illustrated in FIG. 3, the image scanning device 130 is provided at an upper portion of the image forming apparatus 100. The image scanning device 130 sequentially scans the paper set by the user.

An installation mode of the image scanning device 130 is not limited to the mode illustrated in FIG. 3. The image scanning device 130 may be provided inside the image forming apparatus 100 and on a transport path of the paper P.

In this case, the paper P on which an image is formed by the forming function unit 100A passes through the image scanning device 130 in order. In a case where the paper P passes through the scanning position, each image of the paper P is sequentially scanned.

In addition, in the present exemplary embodiment, the image scanning device 130 is provided with a reversal mechanism for paper. Therefore, the paper can be supplied after front and back are reversed with respect to the scanning position of the image.

In the present exemplary embodiment, the paper on which the image formed on one surface is scanned is reversed and can be supplied to the scanning position again. Therefore, the image on the front surface and the image on the back surface of the paper can be scanned.

Further, in addition to the above, in scanning the image of the paper, the paper may be placed on a document stand (not illustrated) configured with a plate-shaped glass or the like. In this case, the paper placed on the document stand is scanned.

Further, an operation reception unit 132 that receives an operation from a user who uses the image forming apparatus 100 is provided in each of the image forming apparatuses 100.

The operation reception unit 132 is configured with a so-called touch panel. The operation reception unit 132 displays information to the user, and receives the operation performed by the user.

The display of the information to the user and the reception of the operation of the user are not limited to being performed by one operation reception unit 132 as in the present exemplary embodiment, and the operation reception unit 132 and an information display unit may be individually provided.

In the present exemplary embodiment, in a case where the image forming apparatus 100 (see FIG. 1) is diagnosed, first, the forming function unit 100A is operated to form a diagnosis image 61 on the paper P.

Therefore, as indicated by a reference numeral 1A, diagnosis paper CP which is the paper P on which the diagnosis image 61 is formed is generated.

The diagnosis image 61 is an image to be used for diagnosing the image forming apparatus 100. In the present exemplary embodiment, the diagnosis paper CP which is the paper P on which the diagnosis image 61 used for diagnosis is formed is generated.

In a case where the diagnosis paper CP is generated, as indicated by a reference numeral 1B in FIG. 1, the diagnosis paper CP is placed in the image scanning device 130. The image scanning device 130 is used to scan the diagnosis paper CP on which the diagnosis image 61 is formed.

Therefore, scan image data obtained by scanning the diagnosis paper CP is generated.

In the present exemplary embodiment, the scan image data is transmitted to the server apparatus 200, and then is stored in the server apparatus 200.

The server apparatus 200 diagnoses the image forming apparatus 100 based on the scan image data. The server apparatus 200 generates state information, which is information on a state of the image forming apparatus 100, based on the scan image data.

In the present exemplary embodiment, the user or the maintenance person of the image forming apparatus 100 accesses the server apparatus 200 via the user terminal 300, and refers to the state information.

In each of the image forming apparatuses 100, the diagnosis paper CP is generated in this manner, and the diagnosis paper CP is scanned to generate scan image data.

Such scan image data is transmitted to the server apparatus 200.

As described above, in the present exemplary embodiment, the state information of the image forming apparatus 100 is generated by the server apparatus 200. Thereafter, the user or the maintenance person of the image forming apparatus 100 refers to the state information.

### Diagnosis Process by Server Apparatus 200

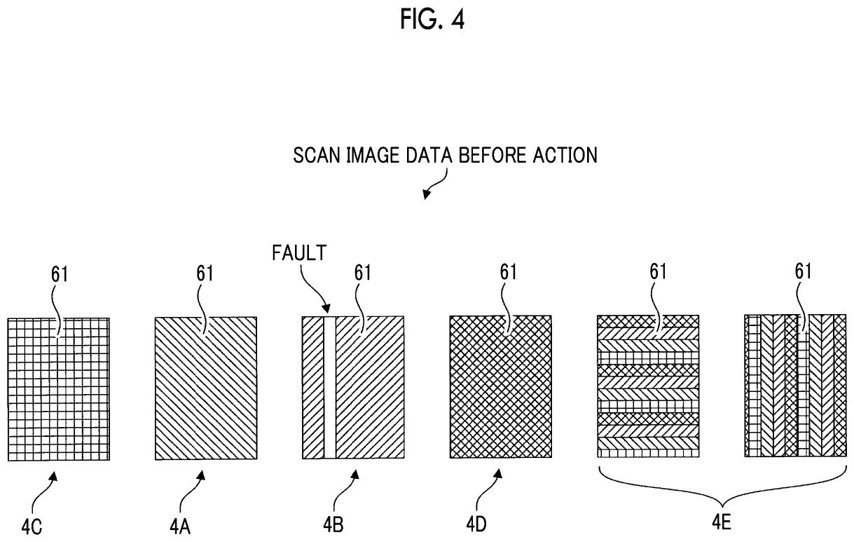

FIG. 4 is a diagram describing details of a diagnosis process by the server apparatus 200.

In the present exemplary embodiment, first, the CPU 11a (see FIG. 2) as an example of a processor provided in the server apparatus 200 (see FIG. 1) acquires scan image data transmitted from the image forming apparatus 100 as described above.

The CPU 11a of the server apparatus 200 diagnoses the image forming apparatus 100 based on the acquired scan image data. More specifically, the CPU 11a of the server apparatus 200 analyzes the diagnosis image 61 that is an image formed on the diagnosis paper CP to perform the diagnosis on the image forming apparatus 100.

FIG. 4 illustrates the scan image data transmitted from the image forming apparatus 100 to the server apparatus 200. The scan image data includes a plurality of diagnosis images 61.

Although not described above, in the image forming apparatus 100, a plurality of diagnosis papers CP (see FIG. 1) on which the diagnosis image 61 is formed are generated. The image scanning device 130 scans the diagnosis images 61 formed on the plurality of diagnosis support papers CP.

Therefore, the scan image data illustrated in FIG. 4 is generated. The scan image data includes the plurality of diagnosis images 61.

In the present exemplary embodiment, the diagnosis image 61 is generated for each image forming unit 107.

The diagnosis image 61 indicated by a reference numeral 4A in FIG. 4 is the diagnosis image 61 formed by the image forming unit 107Y of Yellow (see FIG. 3). Further, the diagnosis image 61 indicated by a reference numeral 4B is the diagnosis image 61 formed by the image forming unit 107M of Magenta.

Further, the diagnosis image 61 indicated by a reference numeral 4C is the diagnosis image 61 formed by the image forming unit 107C of Cyan. Further, the diagnosis image 61 indicated by a reference numeral 4D is the diagnosis image 61 formed by the image forming unit 107K of Black.

Further, each of the diagnosis images 61 indicated by a reference numeral 4E in FIG. 4 is the diagnosis image 61 formed by using the plurality of image forming units 107.

Here, these diagnosis images 61 are examples of a pre-action image. In the present exemplary embodiment, as will be described below, an action for the image forming apparatus 100 is performed by an action operator.

Each of the diagnosis images 61 illustrated in FIG. 4 is a pre-action image that is an image formed by the image forming apparatus 100 before the action is performed.

The scan image data illustrated in FIG. 4 is scan image data obtained by scanning the pre-action image.

Hereinafter, in the present specification, the scan image data obtained by scanning the pre-action image may be referred to as “pre-action image information”.

In a case where the CPU 11a of the server apparatus 200 (see FIG. 1) acquires the pre-action image information, the CPU 11a specifies a candidate for an action to be performed by the action operator on the image forming apparatus 100 based on the pre-action image information.

More specifically, first, the CPU 11a of the server apparatus 200 specifies a candidate for a cause of a fault occurring in the image formed by the image forming apparatus 100 based on the pre-action image information.

The CPU 11a of the server apparatus 200 specifies a candidate for the action based on this specified candidate for the cause of the fault.

In a case where the diagnosis image 61 illustrated in FIG. 4 is obtained, the CPU 11a of the server apparatus 200 specifies “photosensitive drum of Magenta” and “developing device of Magenta”, as candidates for the cause of the fault.

In other words, in a case where the pre-action image illustrated in FIG. 4 is obtained, the CPU 11a of the server apparatus 200 specifies the “photosensitive drum of Magenta” and the “developing device of Magenta”, as the candidates for the cause of the fault.

Next, the CPU 11a of the server apparatus 200 specifies “replacement of photosensitive drum of Magenta” and “replacement of developing device of Magenta”, as the candidates for the action, based on this specified candidates for the cause of the fault.

In the example illustrated in FIG. 4, a streak-shaped fault occurs in the diagnosis image 61 indicated by the reference numeral 4B, which is formed by the image forming unit 107M of Magenta.

In this case, the CPU 11a of the server apparatus 200 specifies “photosensitive drum of Magenta” and “developing device of Magenta” as candidates for a cause of the fault.

In the present exemplary embodiment, a content of the fault and the candidate for the cause of the fault are stored in the secondary storage unit 12 (see FIG. 2). The content of the fault and the candidate for the cause of the fault are stored in the secondary storage unit 12 in a state of being associated with each other.

The CPU 11a of the server apparatus 200 specifies the candidate for the cause of the fault, based on the content of the fault obtained by analyzing the diagnosis image 61, which is a pre-action image, and the information stored in the secondary storage unit 12.

The CPU 11a of the server apparatus 200 acquires, from the secondary storage unit 12, the candidate for the cause of the fault, which is associated with the content of the fault obtained by analyzing the diagnosis image 61 which is a pre-action image. The CPU 11a of the server apparatus 200 specifies the candidate for the cause of the fault acquired from the secondary storage unit 12, as the candidate for the cause of the fault.

Here, as described above, the CPU 11a of the server apparatus 200 specifies the “photosensitive drum of Magenta” and the “developing device of Magenta” as the candidates for the cause of the fault.

In this case, the CPU 11a of the server apparatus 200 specifies the “replacement of photosensitive drum of Magenta” and the “replacement of developing device of Magenta”, as the candidates for the action as described above, based on the specified candidates for the cause.

In the present exemplary embodiment, the candidate for the cause of the fault and the candidate for the action are stored in the secondary storage unit 12. The candidate for the cause of the fault and the candidate for the action are stored in the secondary storage unit 12 in a state of being associated with each other.

The CPU 11a of the server apparatus 200 specifies the candidate for the action, based on the specified candidate for the cause of the fault described above and the information stored in the secondary storage unit 12.

The CPU 11a of the server apparatus 200 acquires the candidate for the action associated with the specified candidate for the cause of the fault from the secondary storage unit 12. The CPU 11a of the server apparatus 200 specifies this candidate for the action acquired from the secondary storage unit 12, as a candidate for the action.

Specifically, in the present exemplary embodiment, as described above, the CPU 11a of the server apparatus 200 specifies the “replacement of photosensitive drum of Magenta” and the “replacement of developing device of Magenta”, as the candidates for the action.

Thereafter, the CPU 11a of the server apparatus 200 generates information for notifying an action operator who takes action for the image forming apparatus 100 of the information on this specified candidate for the action (hereinafter, referred to as “action candidate information”, in some cases).

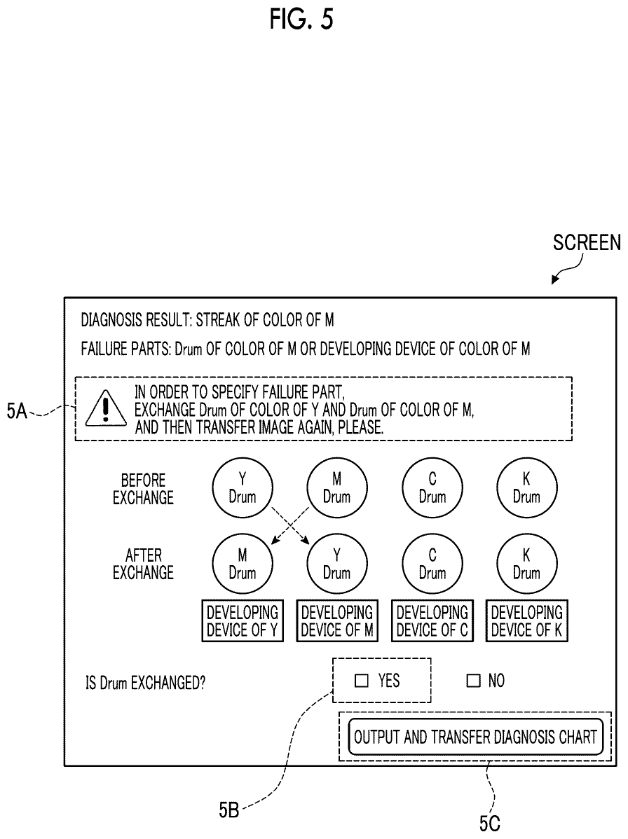

The CPU 11a of the server apparatus 200 generates a screen illustrated in FIG. 5 (a diagram illustrating a screen to be referred to by the action operator) in a case of notifying the action operator of the action candidate information. Further, the CPU 11a of the server apparatus 200 generates information for presenting this screen to the action operator.

Therefore, for example, the screen illustrated in FIG. 5 is displayed on the operation reception unit 132 (refer to FIG. 1) of the image forming apparatus 100. This screen may be displayed on the user terminal 300.

As a result, the action to be performed on the image forming apparatus 100 is notified to the action operator. Examples of the action operator include a user of the image forming apparatus 100.

In generating the screen illustrated in FIG. 5, the CPU 11a of the server apparatus 200 specifies an action to be notified to the action operator from among the specified candidates for the action described above, in accordance with a predetermined standard. In the present specification, hereinafter, this action to be notified to the action operator may be referred to as a notification target action.

In this example, as indicated by a reference numeral 5A in FIG. 5, the CPU 11a of the server apparatus 200 specifies “replacement of photosensitive drum of Magenta” as the notification target process, from the “replacement of photosensitive drum of Magenta” and the “replacement of developing device of Magenta” which are candidates for the action.

Examples of the “predetermined standard” include ease of the action or a cost of the action.

In specifying the action to be notified to the action operator, the CPU 11a of the server apparatus 200 specifies an action that is easy to be handled, for example, among the “replacement of photosensitive drum of Magenta” and the “replacement of developing device of Magenta”. The CPU 11a of the server apparatus 200 specifies an action, and notifies the action operator of the action.

Alternatively, in specifying the action to be notified to the action operator, the CPU 11a of the server apparatus 200 specifies an action having a smaller cost required for the action, for example, out of the “replacement of photosensitive drum of Magenta” and the “replacement of developing device of Magenta”. The CPU 11a of the server apparatus 200 specifies an action, and notifies the action operator of the action.

In the present exemplary embodiment, as described above, the CPU 11a of the server apparatus 200 includes, as indicated the reference numeral 5A in FIG. 5, information indicating that “replacement of photosensitive drum of Magenta” is to be performed, on the screen to be referred to by the action operator.

More specifically, in this example, the CPU 11a of the server apparatus 200 includes information indicating that an exchange of “photosensitive drum of Magenta” and “photosensitive drum of Yellow” is to be performed, on the screen to be referred to by the action operator.

Thereafter, in this process example, the action operator takes the action for the image forming apparatus 100. Specifically, the action of the exchange of the “photosensitive drum of Magenta” and the “photosensitive drum of Yellow” is performed by the action operator.

Here, a movement action of moving an installation member installed in one image forming unit 107 to another image forming unit 107 to install the installation member is performed. The action of “replacement of photosensitive drum of Magenta” corresponds to this movement action.

Here, a movement action of moving the “photosensitive drum of Magenta” which is an example of an installation member installed in the image forming unit 107M of Magenta (see FIG. 3) which is an example of one image forming unit 107 is performed.

In this movement action, an action of moving the “photosensitive drum of Magenta” to the image forming unit 107Y of Yellow which is an example of another image forming unit 107 is performed. Further, in this movement action, an action of installing the “photosensitive drum of Magenta” in the image forming unit 107Y of Yellow is performed.

Further, in the present exemplary embodiment, an action of moving the “photosensitive drum of Yellow” installed in the image forming unit 107Y of Yellow to the image forming unit 107M of Magenta is performed.

In a case where the movement action is finished, the action operator selects a part indicated by a reference numeral 5B on the screen illustrated in FIG. 5, and inputs information indicating that the movement action is finished. Therefore, the image forming apparatus 100 recognizes that the movement action is finished.

Accordingly, in the present exemplary embodiment, a start button indicated by a reference numeral 5C is enabled. Therefore, the action operator can select the start button. The action operator selects the start button.

As a result, the diagnosis image 61 is formed again in the image forming apparatus 100. In the same manner as described above, scan image data of the diagnosis image 61 is generated.

In the present exemplary embodiment, in this manner, the new diagnosis image 61 is formed under a condition in which the image forming apparatus 100 recognizes that the movement action is finished.

Therefore, it is prevented that the new diagnosis image 61 is formed even though the movement action is not performed.

The new diagnosis image 61 corresponds to a post-action image that is an image formed by the image forming apparatus 100 after the action for the image forming apparatus 100 is performed by the action operator.

In the present exemplary embodiment, the scan image data for the post-action image is transmitted to the server apparatus 200.

Hereinafter, in the present specification, the scan image data obtained by scanning the post-action image may be referred to as “post-action image information”.

With the above process, the CPU 11a of the server apparatus 200 acquires the post-action image information.

In the present exemplary embodiment, one action included in the candidates for the action described above is performed by the action operator. After this one action is performed, a post-action image, which is the diagnosis image 61 newly formed by the image forming apparatus 100, is generated.

In the present exemplary embodiment, the CPU 11a of the server apparatus 200 acquires post-action image information obtained by scanning the post-action image.

The CPU 11a of the server apparatus 200 generates state information, which is information on a state of the image forming apparatus 100, based on the post-action image information.

The CPU 11a of the server apparatus 200 generates cause information that is information on a cause of a fault occurring in an image formed by the image forming apparatus 100, based on the post-action image information.

The CPU 11a of the server apparatus 200 specifies the cause from among candidates for the cause of the fault based on the post-action image information. The CPU 11a of the server apparatus 200 includes the cause information, which is information on the specified cause, in the state information indicating the state of the image forming apparatus 100.

The CPU 11a of the server apparatus 200 generates information including the cause information that is information on the cause of the fault occurring in the image formed by the image forming apparatus 100 as the state information.

In the present exemplary embodiment, as described above, the candidates for the cause of the fault are “photosensitive drum of Magenta” and “developing device of Magenta”.

The CPU 11a of the server apparatus 200 specifies a cause from the two candidates for the cause of the “photosensitive drum of Magenta” and the “developing device of Magenta”, based on the post-action image information.

Specifically, the CPU 11a of the server apparatus 200 selects one of the two candidates for the cause of the “photosensitive drum of Magenta” and the “developing device of Magenta” based on the post-action image information to specify a final cause.

The CPU 11a of the server apparatus 200 generates cause information that is information on the cause of the fault occurring in the image formed by the image forming apparatus 100, based on this specified cause.

In the present exemplary embodiment, the action operator performs any action included in the candidates for the action, on the image forming apparatus 100.

The CPU 11a of the server apparatus 200 generates state information, which is information on a state of the image forming apparatus 100, based on a post-action image formed by the image forming apparatus 100 after the action operator performs any of the actions on the image forming apparatus 100.

First, the CPU 11a of the server apparatus 200 generates the cause information described above, and then generates the state information including the cause information.

In the present exemplary embodiment, as described above, not all the candidates for the action are notified to the action operator.

In the present exemplary embodiment, as described above, the information on the action specified from among the candidates for the action is notified to the action operator. In the present exemplary embodiment, the “replacement of photosensitive drum of Magenta” is notified to the action operator.

In addition, in the present exemplary embodiment, the action operator who receives the notification of the information on the action performs an action specified by the information on the action. Specifically, in the present exemplary embodiment, the “replacement of photosensitive drum of Magenta” is performed.

The CPU 11a of the server apparatus 200 generates the state information of the image forming apparatus 100 based on the post-action image formed by the image forming apparatus 100 after the “replacement of photosensitive drum of Magenta” is performed.

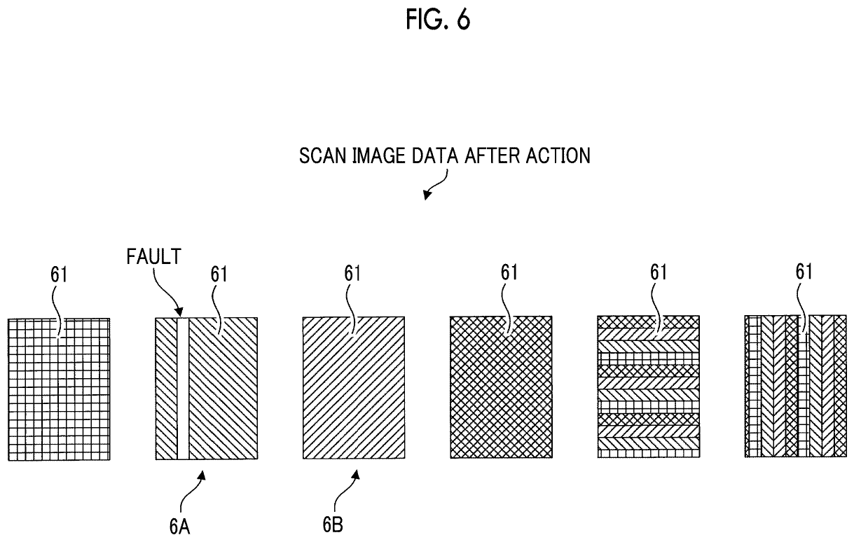

FIG. 6 is a diagram illustrating a post-action image formed after “replacement of photosensitive drum of Magenta”. In other words, FIG. 6 illustrates the diagnosis image 61 formed after a movement action is performed.

The CPU 11a of the server apparatus 200 acquires scan image data of the post-action image as post-action image information.

The CPU 11a of the server apparatus 200 specifies a cause of a fault based on the post-action image information, and generates cause information. The CPU 11a of the server apparatus 200 generates information including the cause information as state information of the image forming apparatus 100.

In the diagnosis image 61 illustrated in FIG. 6, a fault occurs in a post-action image formed by using “photosensitive drum of Magenta”.

More specifically, in this example, a streak-shaped fault occurs in the diagnosis image 61 indicated by a reference numeral 6A, which is formed by the image forming unit 107Y of Yellow on which the “photosensitive drum of Magenta” is installed.

In this example, among the plurality of diagnosis images 61 as the post-action images, the diagnosis image 61 formed by the image forming unit 107Y of Yellow has the streak-shaped fault.

On the other hand, in the diagnosis image 61 indicated by a reference numeral 6B formed by the image forming unit 107M of Magenta on which “photosensitive drum of Yellow” is installed, no fault occurs.

In this case, the CPU 11a of the server apparatus 200 specifies that a cause of a fault in a pre-action image is the “photosensitive drum of Magenta”.

That is, the CPU 11a of the server apparatus 200 generates cause information indicating that the cause of the fault in the pre-action image is the “photosensitive drum of Magenta”.

In other words, the CPU 11a of the server apparatus 200 generates the cause information indicating that the cause of the fault in the pre-action image is in the “photosensitive drum of Magenta” that is the installation member described above, which is moved by the movement action described above.

Thereafter, the CPU 11a of the server apparatus 200 generates state information, which is information indicating a state of the image forming apparatus 100, based on the generated cause information.

Here, the CPU 11a of the server apparatus 200 generates information indicating that a defect occurs in the “photosensitive drum of Magenta” as the state information.

Thereafter, in the present exemplary embodiment, the state information is notified to the action operator through the operation reception unit 132 (see FIG. 1). Alternatively, the state information is notified to the action operator through the user terminal 300.

Here, information indicating that a defect occurs in the “photosensitive drum of Magenta” is notified to the action operator.

As described above, the CPU 11a of the server apparatus 200 acquires information on the pre-action image which is an image formed by the image forming unit 107M of Magenta before the movement action is performed. In the present exemplary embodiment, a fault occurs in this pre-action image.

In addition, in the present exemplary embodiment, as described above, a fault also occurs in the post-action image.

Specifically, in the present exemplary embodiment, the fault occurs in the post-action image which is an image formed by the image forming unit 107Y of Yellow after the movement action is performed.

In other words, in the present exemplary embodiment, the fault also occurs in the post-action image which is an image formed by the image forming unit 107Y of Yellow on which the “photosensitive drum of Magenta” which is an example of the installation member is installed.

In this manner, in a case where the fault occurs in the pre-action image and the fault occurs in the post-action image formed by using the installation member, the CPU 11a of the server apparatus 200 generates information indicating that the installation member is the cause of the fault.

Specifically, in this case, the CPU 11a of the server apparatus 200 generates information indicating that the “photosensitive drum of Magenta” is the cause of the fault.

In this case, the CPU 11a of the server apparatus 200 generates, for example, information indicating that a defect occurs in the “photosensitive drum of Magenta” as the state information on the image forming apparatus 100.

In addition, a case is also assumed in which a fault occurs in a pre-action image, and a fault does not occur in a post-action image formed by using the installation member.

Specifically, a case where a fault occurs in a pre-action image formed by the image forming unit 107M of Magenta and a fault does not occur in a post-action image formed by the image forming unit 107Y of Yellow in which “photosensitive drum of Magenta” as the installation member is installed is also assumed.

In this case, the CPU 11a of the server apparatus 200 generates information indicating that a cause of the fault is in a member other than the installation member among the members provided in the image forming unit 107M of Magenta.

Specifically, in this case, the CPU 11a of the server apparatus 200 generates information indicating that the cause of the fault is in a member other than the “photosensitive drum of Magenta” among the members provided in the image forming unit 107M of Magenta.

More specifically, in this case, the CPU 11a of the server apparatus 200 generates information indicating that the cause of the fault is in “developing device of Magenta” among the members provided in the image forming unit 107M of Magenta.

In this case, the CPU 11a of the server apparatus 200 generates information indicating that the defect occurs in the “developing device of Magenta” as the state information on the image forming apparatus 100.

In the present exemplary embodiment, as described above, “photosensitive drum of Magenta” and “developing device of Magenta” are specified as candidates for a cause of a fault.

In a case where a fault occurs in the post-action image formed by using the “photosensitive drum of Magenta” which is one candidate for the cause, the CPU 11a of the server apparatus 200 specifies the “photosensitive drum of Magenta” as the cause of the fault.

In this case, as described above, the CPU 11a of the server apparatus 200 generates information indicating that a defect occurs in the “photosensitive drum of Magenta” as the state information on the image forming apparatus 100.

In the present exemplary embodiment, in this manner, in a case where a fault occurs in the image formed by the image forming unit 107 as a movement destination of the installation member, the installation member is specified as a cause of the fault.

In addition, in a case where a fault does not occur in a post-action image formed by using the “photosensitive drum of Magenta” that is the one candidate for a cause described above, the CPU 11a of the server apparatus 200 specifies the “developing device of Magenta” that is the other candidate for the cause, as the cause of the fault.

In this case, the CPU 11a of the server apparatus 200 generates information indicating that a defect occurs in the “developing device of Magenta” as state information on the image forming apparatus 100.

In the present exemplary embodiment, in this manner, in a case where no fault occurs in an image formed by the image forming unit 107 as a movement destination of an installation member, another member other than the installation member, which is installed in a movement source of the installation member, is specified as a cause of the fault.

### Another Process Example

Here, a case where a cleaning action is performed will be described as an example.

As described above, in the present exemplary embodiment, the CPU 11a of the server apparatus 200 first specifies a candidate for a cause, and then specifies a candidate for an action based on the specified candidate for the cause.

Here, a case where the CPU 11a of the server apparatus 200 specifies a seal member provided in the developing device 103 (see FIG. 3) as a candidate for a cause of a fault will be described as an example.

Further, here, a case where the CPU 11a of the server apparatus 200 specifies “cleaning of seal member” as a candidate for an action will be described as an example.

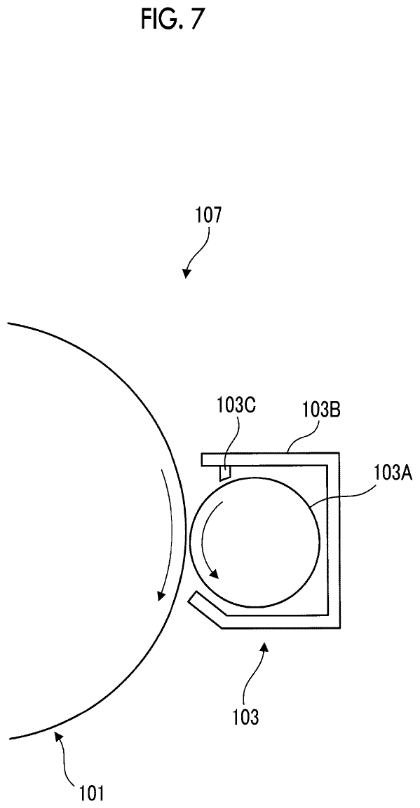

FIG. 7 is an enlarged view of the developing device 103.

The developing device 103 is provided with a seal member 103C for filling a gap between the developing roll 103A and a device main body 103B of the developing device 103.

Due to the seal member 103C, a toner causes an adhesion unevenness on a surface of the developing roll 103A, in some cases. In this case, the uneven adhesion may affect an image formed by the image forming apparatus 100, and a fault may occur in the formed image.

The seal member 103C is disposed in a non-contact state with respect to the developing roll 103A.

The toner adhering to the surface of the developing roll 103A passes through a gap between the seal member 103C and the surface of the developing roll 103A, and heads toward the photosensitive drum 101.

In the present exemplary embodiment, by allowing the toner to pass through the gap, a thickness of the toner adhering to the surface of the developing roll 103A is a predetermined specific thickness.

In a case where an action of cleaning is specified as a candidate for the action, the action of cleaning is notified to the action operator in the same manner as described above. Accordingly, the action of cleaning is performed by the action operator.

Specifically, here, as the action of cleaning, “cleaning of seal member” is specified, and an action of “cleaning of seal member” is notified to the action operator.

Thereafter, the same procedure as described above is performed, and then the image forming apparatus 100 forms the diagnosis image 61 after performing this action. In other words, the image forming apparatus 100 forms a post-action image.

Accordingly, the CPU 11a of the server apparatus 200 acquires post-action image information in the same manner as described above.

Here, the CPU 11a of the server apparatus 200 acquires information on the post-action image formed by the image forming apparatus 100 after the action of “cleaning of seal member” is performed by an operator.

In addition, in this process example, the CPU 11a of the server apparatus 200 acquires information on a pre-action image formed by the image forming apparatus 100 before the action of “cleaning of seal member” is performed on the image forming apparatus 100 as pre-action image information.

Although not described above, the CPU 11a of the server apparatus 200 specifies the seal member 103C as a candidate for a cause of a fault in the image based on the pre-action image obtained before the action of “cleaning of seal member”.

Further, the CPU 11a of the server apparatus 200 specifies the “cleaning of seal member” as a candidate for the action based on the candidate for the cause of the fault.

In this example, the candidate for the action is only one of “cleaning of seal member”. In this case, information on the action of “cleaning of seal member” is notified to the action operator.

After the action of “cleaning of seal member” is performed by the action operator, the diagnosis image 61 in the second time is formed by the image forming apparatus 100. Therefore, even in this case, the CPU 11a of the server apparatus 200 acquires the post-action image information.

The post-action image information is information obtained by scanning the post-action image formed by the image forming apparatus 100 after the action of “cleaning of seal member”.

Thereafter, the CPU 11a of the server apparatus 200 specifies the cause of the fault based on the pre-action image obtained before the action of the cleaning and the post-action image obtained after the action of the cleaning.

In a case where a fault occurs in the pre-action image and the fault does not occur in the post-action image, the CPU 11a of the server apparatus 200 generates information indicating that a location at which the action of “cleaning of seal member” is performed is a cause of the fault.

Specifically, in this case, the CPU 11a of the server apparatus 200 generates information indicating that the seal member 103C is the cause of the fault.

In this case, the CPU 11a of the server apparatus 200 generates, for example, information indicating that a defect occurs in the seal member 103C of the developing device 103 as state information on the image forming apparatus 100.

On the other hand, a case where a fault occurs in the pre-action image and the fault occurs in the post-action image is assumed. In this case, the CPU 11a of the server apparatus 200 specifies that a cause of the fault exits in a location other than the location at which the action of “cleaning of seal member” is performed in the image forming apparatus 100.

Specifically, the CPU 11a of the server apparatus 200 specifies that the cause of the fault is in a location other than the seal member 103C in the image forming apparatus 100.

In this case, the CPU 11a of the server apparatus 200 generates, for example, information indicating that a defect occurs in a location other than the seal member 103C as the state information on the image forming apparatus 100.

### Other Processes

In the above description, a case where an action notification is given to an action operator is described as an example. In addition, a mode in which the action is not notified to the action operator is also considered.

For example, a case where the action operator of the image forming apparatus 100 generates the first diagnosis paper CP, performs the action on the image forming apparatus 100, and generates the second diagnosis paper CP based on a determination of the action operator is also assumed.

In other words, a case is also assumed in which the action operator of the image forming apparatus 100 forms a pre-action image, performs the action on the image forming apparatus 100, and forms a post-action image based on the determination of the action operator.

In this case, scan image data of the first diagnosis paper CP and scan image data of the second diagnosis paper CP are transmitted to the server apparatus 200. In other words, also in this case, post-action image information and pre-action image information are transmitted to the server apparatus 200.

Further, in this case, action content information, which is information indicating a content of an action to be performed by the action operator on the image forming apparatus 100, is also transmitted to the server apparatus 200.

Here, the content of the action to be performed by the action operator on the image forming apparatus 100 is automatically specified by the image forming apparatus 100, for example. Alternatively, the content of this action is specified based on information input to the image forming apparatus 100 by the action operator.

In this case, the CPU 11a of the server apparatus 200 generates cause information based on the post-action image information, the pre-action image information, and the action content information. Next, the CPU 11a of the server apparatus 200 generates state information of the image forming apparatus 100 based on the cause information.

Here, in the same manner as the above description, a case where the action specified by the action content information is an exchange of the “photosensitive drum of Magenta” and the “photosensitive drum of Yellow” will be described as an example.

In other words, here, a case where the action specified by the action content information is a movement action of moving the “photosensitive drum of Magenta” will be described as an example.

Further, here, a case where a fault occurs in the diagnosis image 61 of Magenta in the pre-action image as described above is assumed. In addition, here, a case where a fault occurs in a post-action image which is an image formed by the image forming unit 107Y of Yellow after the movement action is performed is assumed.

In this case, the CPU 11a of the server apparatus 200 specifies that the “photosensitive drum of Magenta” provided in the image forming unit 107M of Magenta is a cause of the fault.

More specifically, in this process, first, the CPU 11a of the server apparatus 200 specifies that a candidate for the cause of the fault is the “photosensitive drum of Magenta” and the “developing device of Magenta” based on the pre-action image information.

Next, the CPU 11a of the server apparatus 200 specifies that the cause of the fault is the “photosensitive drum of Magenta” based on the action content information indicating that the movement action of moving the “photosensitive drum of Magenta” is performed and the information indicating that the fault occurs in the post-action image which is an image formed by the image forming unit 107Y of Yellow.

In this case, the CPU 11a of the server apparatus 200 generates information indicating that a defect occurs in the “photosensitive drum of Magenta” as the state information on the image forming apparatus 100.

In addition, a case is assumed in which, after the movement action described above is performed, no fault occurs in the image formed by the image forming unit 107Y of Yellow.

In this case, the CPU 11a of the server apparatus 200 specifies the “developing device of Magenta” provided in the image forming unit 107M of Magenta as the cause of the fault.

More specifically, also in this case of the process, the CPU 11a of the server apparatus 200 specifies, in the same manner as the above description, the candidate for the cause of the fault as the “photosensitive drum of Magenta” and the “developing device of Magenta” based on the pre-action image information.

Next, the CPU 11a of the server apparatus 200 specifies that the cause of the fault is the “developing device of Magenta” based on the action content information indicating that the movement action of “photosensitive drum of Magenta” is performed and the information indicating that the fault does not occur in the post-action image which is the image formed by the image forming unit 107Y of Yellow.

In this case, the CPU 11a of the server apparatus 200 generates information indicating that a defect occurs in the “developing device of Magenta” as state information on the image forming apparatus 100.

In addition, for example, a case where the action specified by the action content information is an action of “cleaning the seal member”, and a fault exists in the pre-action image and no fault exists in the post-action image is assumed.

In this case, the CPU 11a of the server apparatus 200 generates information indicating that the seal member 103C on which cleaning is performed is the cause of the fault.

In addition, in this case, the CPU 11a of the server apparatus 200 generates, for example, information indicating that a defect occurs in the seal member 103C of the developing device 103, as the state information on the image forming apparatus 100.

In addition, for example, a case where the action specified by the action content information is the action of “cleaning the seal member”, a fault exists in the pre-action image, and the fault exists in the post-action image is assumed.

In this case, the CPU 11a of the server apparatus 200 generates information indicating that a location other than the seal member 103C on which the cleaning is performed is the cause of the fault.

In this case, the CPU 11a of the server apparatus 200 generates, for example, information indicating that a defect occurs in a location other than the seal member 103C in the image forming apparatus 100 as the state information on the image forming apparatus 100.

### Supplementary Note

(((1)))

An information processing system comprising:
a processor configured to:
   acquire post-action image information that is information on a post-action image, which is an image formed by an image forming apparatus after an action is performed on the image forming apparatus by an action operator;
   acquire pre-action image information that is information on a pre-action image, which is an image formed by the image forming apparatus before the action is performed by the action operator; and
   generate state information that is information on a state of the image forming apparatus, based on the post-action image information and the pre-action image information.
      (((2)))

The information processing system according to (((1))), wherein the processor is configured to:
generate information including cause information that is information on a cause of a fault occurring in the image formed by the image forming apparatus, as the state information.
   (((3)))

The information processing system according to (((1))) or (((2))), wherein the processor is configured to:
specify a candidate for an action to be performed on the image forming apparatus by the action operator, based on the pre-action image information; and
generate the state information, based on the post-action image information that is information on the post-action image, which is an image formed by the image forming apparatus after the action included in the candidate for the action is performed by the action operator.
   (((4)))

The information processing system according to (((3))), wherein the processor is configured to:
generate information including cause information that is information on a cause of a fault occurring in the image formed by the image forming apparatus, as the state information, based on the post-action image information.
   (((5))

The information processing system according to (((4))), wherein the processor is configured to:
specify a candidate for the cause of the fault occurring in the image formed by the image forming apparatus based on the pre-action image information, and specify the candidate for the action based on the specified candidate for the cause; and specify the cause from among candidates for the cause based on the post-action image information that is information on the post-action image, which is an image formed by the image forming apparatus after the action included in the specified candidate for the action is performed by the action operator, and generate the cause information that is information on the cause of the fault occurring in the image formed by the image forming apparatus.
   (((6)))

The information processing system according to any one of (((1))) to (((5))), wherein the processor is configured to:
acquire information on a post-action image that is an image formed by the image forming apparatus after an action of cleaning is performed on the image forming apparatus by an operator, as the post-action image information;
acquire information on a pre-action image that is an image formed by the image forming apparatus before the action of cleaning is performed on the image forming apparatus, as the pre-action image information; and
generate the state information based on the pre-action image information on the pre-action image obtained before the action of cleaning and the post-action image information on the post-action image obtained after the action of cleaning.
   (((7)))

The information processing system according to (((6))), wherein the processor is configured to:
in a case where a fault occurs in the pre-action image specified by the pre-action image information and a fault does not occur in the post-action image specified by the post-action image information, generate information indicating that a cause of the fault is in a location at which the action of cleaning is performed in the image forming apparatus, as the state information.
   (((8)))

The information processing system according to any one of (((1))) to (((7))), wherein the processor is configured to:
specify a candidate for an action to be performed by the action operator, which is an action to be performed on the image forming apparatus, based on the pre-action image information;
generate information for notifying the action operator of information on the specified candidate for the action; and
generate the state information based on the post-action image obtained by the image forming apparatus after the action is performed by the action operator who receives the notification of the information on the candidate for the action and the pre-action image obtained by the image forming apparatus before the action is performed.
   (((9)))

The information processing system according to any one of (((1))) to (((5))),
wherein a plurality of image forming units that form an image are provided in the image forming apparatus, and
the processor is configured to:
   acquire information on a post-action image that is an image, after a movement action of moving an installation member installed in one image forming unit to another image forming unit and installing the installation member in the other image forming unit is performed, formed by the other image forming unit, as the post-action image information; and
   acquire information on a pre-action image that is an image formed by the one of the image forming units before the movement action of moving the installation member is performed, as the pre-action image information.
      (((10)))

The information processing system according to (((9))), wherein the processor is configured to:
in a case where a fault occurs in the pre-action image that is the image specified by the pre-action image information and a fault does not occur in the post-action image that is the image specified by the post-action image information, generate information indicating that a cause of the fault is in another member other than the installation member among members provided in the one image forming unit, as the state information.
   (((11)

The information processing system according to (((9))), wherein the processor is configured to:
in a case where a fault occurs in the pre-action image that is the image specified by the pre-action image information and a fault occurs in the post-action image that is the image specified by the post-action image information, generate information indicating that a cause of the fault is in the installation member, as the state information.
   (((12)))

An information processing system comprising:
a processor configured to:
   specify a candidate for an action to be performed on an image forming apparatus based on an image formed by the image forming apparatus; and
   generate information on a state of the image forming apparatus based on an image formed by the image forming apparatus after an action included in the candidate for the action is performed on the image forming apparatus by an action operator.
      (((13)))

The information processing system according to (((12))), wherein the processor is configured to:
further generate information for notifying action candidate information, which is information on the specified candidate for the action, of the action operator who performs the action on the image forming apparatus.
   (((14)))

An image forming apparatus comprising:
an image forming section that forms an image on a recording material; and
an information processing system that generates information on a state of the image forming apparatus,
wherein the information processing system is configured with the information processing system according to any one of (((1))) to (((13))).
   (((15)))

A program causing a computer to realize:
a function of acquiring post-action image information that is information on a post-action image, which is an image formed by an image forming apparatus after an action is performed on the image forming apparatus by an action operator;
a function of acquiring pre-action image information that is information on a pre-action image, which is an image formed by the image forming apparatus before the action is performed by the action operator; and
a function of generating state information that is information on a state of the image forming apparatus, based on the post-action image information and the pre-action image information.
   (((16)))

A program causing a computer to realize:
a function of specifying a candidate for an action to be performed on an image forming apparatus based on an image formed by the image forming apparatus; and
a function of generating information on a state of the image forming apparatus based on an image formed by the image forming apparatus after an action included in the candidate for the action is performed on the image forming apparatus by an action operator.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire post-action image information that is information on a post-action image, which is an image formed by an image forming apparatus after an action is performed on the image forming apparatus by an action operator;
acquire pre-action image information that is information on a pre-action image, which is an image formed by the image forming apparatus before the action is performed by the action operator; and
generate state information that is information on a state of the image forming apparatus, based on the post-action image information and the pre-action image information.

2. The information processing system according to claim 1, wherein the processor is configured to:
generate information including cause information that is information on a cause of a fault occurring in the image formed by the image forming apparatus, as the state information.

3. The information processing system according to claim 1, wherein the processor is configured to:
specify a candidate for an action to be performed on the image forming apparatus by the action operator, based on the pre-action image information; and
generate the state information, based on the post-action image information that is information on the post-action image, which is an image formed by the image forming apparatus after the action included in the candidate for the action is performed by the action operator.

4. The information processing system according to claim 3, wherein the processor is configured to:
generate information including cause information that is information on a cause of a fault occurring in the image formed by the image forming apparatus, as the state information, based on the post-action image information.

5. The information processing system according to claim 4, wherein the processor is configured to:
specify a candidate for the cause of the fault occurring in the image formed by the image forming apparatus based on the pre-action image information, and specify the candidate for the action based on the specified candidate for the cause; and
specify the cause from among candidates for the cause based on the post-action image information that is information on the post-action image, which is an image formed by the image forming apparatus after the action included in the specified candidate for the action is performed by the action operator, and generate the cause information that is information on the cause of the fault occurring in the image formed by the image forming apparatus.

6. The information processing system according to claim 1, wherein the processor is configured to:
acquire information on a post-action image that is an image formed by the image forming apparatus after an action of cleaning is performed on the image forming apparatus by an operator, as the post-action image information;
acquire information on a pre-action image that is an image formed by the image forming apparatus before the action of cleaning is performed on the image forming apparatus, as the pre-action image information; and
generate the state information based on the pre-action image information on the pre-action image obtained before the action of cleaning and the post-action image information on the post-action image obtained after the action of cleaning.

7. The information processing system according to claim 6, wherein the processor is configured to:
in a case where a fault occurs in the pre-action image specified by the pre-action image information and a fault does not occur in the post-action image specified by the post-action image information, generate information indicating that a cause of the fault is in a location at which the action of cleaning is performed in the image forming apparatus, as the state information.

8. The information processing system according to claim 1, wherein the processor is configured to:
specify a candidate for an action to be performed by the action operator, which is an action to be performed on the image forming apparatus, based on the pre-action image information;
generate information for notifying the action operator of information on the specified candidate for the action; and
generate the state information based on the post-action image obtained by the image forming apparatus after the action is performed by the action operator who receives the notification of the information on the candidate for the action and the pre-action image obtained by the image forming apparatus before the action is performed.

9. The information processing system according to claim 1,
wherein a plurality of image forming units that form an image are provided in the image forming apparatus, and
the processor is configured to:
acquire information on a post-action image that is an image, after a movement action of moving an installation member installed in one image forming unit to another image forming unit and installing the installation member in the other image forming unit is performed, formed by the other image forming unit, as the post-action image information; and
acquire information on a pre-action image that is an image formed by the one of the image forming units before the movement action of moving the installation member is performed, as the pre-action image information.

10. The information processing system according to claim 9, wherein the processor is configured to:
in a case where a fault occurs in the pre-action image that is the image specified by the pre-action image information and a fault does not occur in the post-action image that is the image specified by the post-action image information, generate information indicating that a cause of the fault is in another member other than the installation member among members provided in the one image forming unit, as the state information.

11. The information processing system according to claim 9, wherein the processor is configured to:
in a case where a fault occurs in the pre-action image that is the image specified by the pre-action image information and a fault occurs in the post-action image that is the image specified by the post-action image information, generate information indicating that a cause of the fault is in the installation member, as the state information.

12. An information processing system comprising:
a processor configured to:
specify a candidate for an action to be performed on an image forming apparatus based on an image formed by the image forming apparatus; and
generate information on a state of the image forming apparatus based on an image formed by the image forming apparatus after an action included in the candidate for the action is performed on the image forming apparatus by an action operator.

13. The information processing system according to claim 12, wherein the processor is configured to:
further generate information for notifying action candidate information, which is information on the specified candidate for the action, of the action operator who performs the action on the image forming apparatus.

14. An image forming apparatus comprising:
an image forming section that forms an image on a recording material; and
an information processing system that generates information on a state of the image forming apparatus,
wherein the information processing system is configured with the information processing system according to claim 1.

15. A non-transitory computer readable medium storing a program causing a computer to realize:
a function of acquiring post-action image information that is information on a post-action image, which is an image formed by an image forming apparatus after an action is performed on the image forming apparatus by an action operator;
a function of acquiring pre-action image information that is information on a pre-action image, which is an image formed by the image forming apparatus before the action is performed by the action operator; and
a function of generating state information that is information on a state of the image forming apparatus, based on the post-action image information and the pre-action image information.
